(19) United States
(12) Patent Application Publication
(10) Pub. No.: US 2002/0021290 A1
(43) Pub. Date: Feb. 21, 2002

(54) Input pen

(76) Inventor: Yoshihide Mitsuya, Kawagoe-shi (JP)

Correspondence Address: McGinn & Gibb, PLLC, Suite 200, 8321 Old Courthouse Road, Vienna, VA, 22182-3817, US

(21) Appl. No.: 09/929,061

(22) Filed: Aug. 15, 2001

(30) Foreign Application Priority Data
Aug. 17, 2000 (JP) 2000-247306

(51) Int. Cl. G09G 5/00

(52) U.S. Cl. 345/179

(57) ABSTRACT

An input pen is provided with an input pen module including a tip holder detachably fitted thereto for holding a soft input tip having a low hardness or a hard input tip having a high hardness or with a plurality of hard input pen modules capable of being selectively used each including a tip holder holding a hard input tip having a high hardness or a soft input pen module including a tip holder holding a soft input tip having a low hardness. The soft input tip has a durometer hardness in the range of 55° to 69° and the hard input tip has a durometer hardness in the range of 70° to 85°.

### BACKGROUND OF THE INVENTION

1. Field of the Invention

The present invention relates to an input pen for entering information into a computer system provided with a pressure-sensitive input screen.

2. Description of the Related Art

A conventional input pen of this kind is provided with an input tip having a fixed hardness. When writing with a pen, different users apply different pressures, respectively, to the pen. Therefore different users have different preferences for the hardness of the input tip and hence an input pen provided with an input tip having a fixed hardness is unable to satisfy every user. For example, if a person who applies a comparatively high pressure to a pen when writing uses an input pen provided with a comparatively hard input tip, the person will feel unpleasant even if the input pen does not go so far as to damage the input screen. If a person who applies a comparatively low pressure to a pen when writing uses an input pen provided with a comparatively soft input tip, the person's fingers will be superfluously tired. A damaged input screen must be repaired or replaced with a new one, which requires a great expense. Furthermore, some persons have preference for a hard input tip while others have preference for a soft input tip regardless of the pressure they apply to the pen when writing.

### SUMMARY OF THE INVENTION

Accordingly, it is an object of the present invention to provide an input pen capable of making a user feel pleasant regardless the pressure the user applies to a pen when writing and of avoiding unnecessarily fatiguing the user even if the user uses the input pen for a long time.

Another object of the present invention is to provide a multifunctional input pen provided, in combination, with functional modules capable of being selectively used including an input pen module and at least one of bar-shaped modules including a mechanical pencil module, a ballpoint pen module, color pencil modules, an eraser and a chalk.

According to the present invention, an input pen is capable of selectively using a soft tip having a low hardness or a hard tip having a high hardness, or of selectively using a soft tip holder holding a soft tip having a low hardness or a hard tip holder holding a hard tip having a high hardness.

The soft tip of the soft tip holder or the hard tip of the hard tip holder can be selectively projected from the front end of a barrel.

### BRIEF DESCRIPTION OF THE DRAWINGS

The above and other objects, features and advantages of the present invention will become more apparent from the following description taken in connection with the accompanying drawings, in which:

FIG. 1 is a longitudinal sectional view of a multifunctional input pen in a first embodiment according to the present invention;

FIG. 2 is a perspective view showing details of the multifunctional input pen of FIG. 1; and

FIG. 3 is a longitudinal sectional view of an essential part of an input pen in a second embodiment according to the present invention.

### DESCRIPTION OF THE PREFERRED EMBODIMENTS

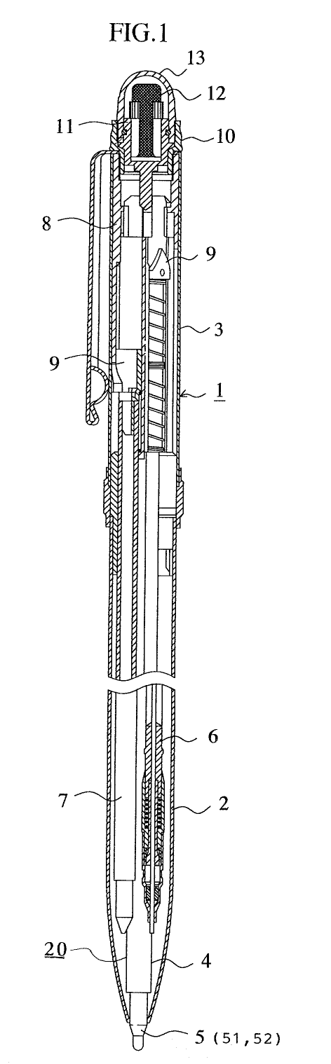

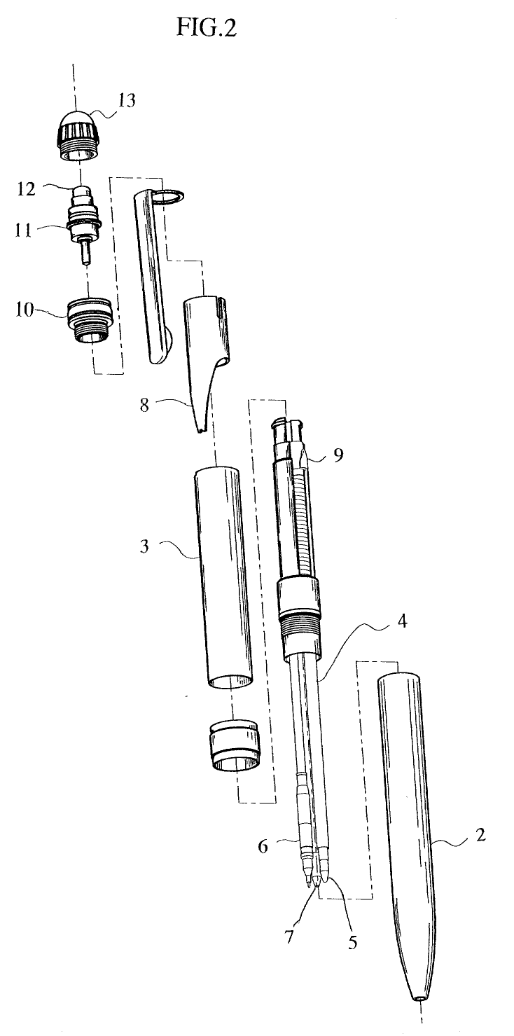

Referring to FIGS. 1 and 2, an input pen in a first embodiment according to the present invention has a barrel 1 including a front barrel 2 and a back barrel 3 capable of rotating relative to the front barrel 2. An input pen module 20 formed by pressing a soft or hard input tip 5 in a front end part of a holder 4, a mechanical pencil module 6 and a ballpoint pen module 7 are held in the barrel 1.

The holder 4 is a flexible pipe of, for example, a synthetic resin. The diameter of a back part to be fitted in the front end part of the holder 4 of the input tip 5 is greater than the inside diameter of the front end part of the holder 4. The input tip 5 is fitted in the front end part of the holder 4 such that the input tip 5 does not fall off the holder and can be replaced with another one.

The input pen module 20, the mechanical pencil module 6 and the ballpoint pen module 7 are used selectively. The tip of the input pen module 20, the mechanical pencil module 6 and the ballpoint pen module 7 can be projected from the front end of the front barrel 2 by turning the back barrel 3 relative to the front barrel 2.

A main cam 8 is fitted fixedly in a back part of the back barrel 3 and a slide cam 9 is engaged with the main cam 8 as a supporting member for the main cam 8. The slide cam 9 has cam ridges. Respective back end parts of the input pen module 20, the mechanical pencil module 6 and the ballpoint pen module 7 are inserted in and attached to the slide cam 9.

An end ring 10 has a small part and a large part fitted in the back end of the back barrel 3. An eraser holder 11 is fitted in the small part of the end ring 10. The eraser holder 11 has a projection extending forward. The slide cam 9 is disposed in front of the projection of the eraser holder 11. An eraser 12 provided with a ferrule is detachably fitted in the eraser holder 11 and an end cap 13 is detachably fitted in the large part of the end ring 10 so as to cover the eraser 12.

The input tip 5 is a soft input tip 51 or a hard input tip 52 and one of them is selectively attached. The soft input tip 51 has a durometer hardness in the range of 55° to 69°. The hard input tip 52 has a durometer hardness in the range of 70° to 85°. The input tip 5 is detachably fitted in the front end part of the holder 4. The soft input tip 51 is suitable for persons who apply a high pressure to a pen when writing. The hard input tip 52 is suitable for persons who apply a low pressure to a pen when writing. A semirigid polyethylene resin is a suitable material for forming the soft input tip 51. A polyoxymethylene resin (POM resin) is a suitable material for forming the hard input tip 52.

The operation of the input pen will be described. In a state where the input pen module 20, the mechanical pencil module 6 and the ballpoint pen module 7 are retracted into the barrel 1, the back barrel 3 is rotated relative to the front barrel 2 to select the input pen module 20, the mechanical pencil module 6 or the ballpoint pen module 7. Suppose that the input pen module 20 provided with the soft input tip 51 is selected. Then the input pen module 20 is pushed forward by the cooperative cam action of the main cam 8 and the sliding cam 9 to project the soft input tip 51 from the front end of the front barrel 2. If the hard input tip 52 is desired, the soft input tip 51 is pulled off the holder 4 and the hard input tip 51 is pressed in the holder 4. The front barrel 2 may be rotated several turns, for example, in a clockwise direction relative to the back barrel 3 to separate the front barrel 2 from the back barrel 3 and the input pen module 20 provided with the soft input tip 51 may be replaced with the input pen module 20 provided with the hard input tip 52.

The input pen in the first embodiment is a multifunctional input pen provided with the mechanical pencil module 6 and the ballpoint pen module 7 in combination with the input pen module 20, and the soft input tip 51 or the hard input tip 52 can be selectively used. The input pen may be provided with a plurality of input pen modules respectively provided with input tips having different hardnesses, and the input pen modules provided with the input tip having a desired hardness may be operated by the module operating cam mechanism of a known writing device to project the input tip having a desired hardness from the front end of the front barrel 2.

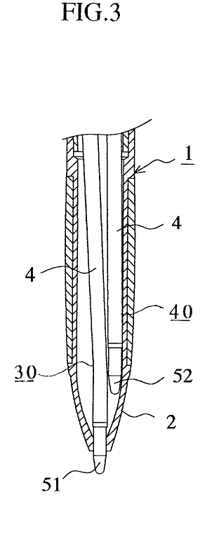

FIG. 3 is a longitudinal sectional view of an essential part of an input pen in a second embodiment according to the present invention. The input pen is provided with a first input pen module 30 provided with a soft input tip 51 and a second input pen module 40 provided with a hard input tip 52. The input tip of the first input pen module 30 or the second input pen module 40 can be projected from the front end of a front barrel 2 by selectively operating the first input pen module 30 or the second input pen module 40 by an input pen module operating mechanism.

As apparent from the foregoing description, the present invention enables the selective use of a plurality of input tips having different hardness. The input pen according to the present invention is provided with the single input pen module having the holder to which an input tip having a desired hardness can be attached or with a plurality of input pen modules respectively provided with input tips having different hardness and capable of being selectively used.

The input pen of the present invention may be a multifunctional input pen provided, in addition to an input pen module, at least one of bar-shaped modules including mechanical pencil modules, ballpoint pens, color pencils, erasers and chokes capable of being selectively used.

A semirigid polyethylene resin is a suitable material for forming the soft input tip 51. A polyoxymethylene resin (POM resin) is a suitable material for forming the hard input tip 52.

Although the input tip 5 fitted in the front end part of the holder 4 of the input pen according to the present invention can be replaced with another one, the input pen module provided with the input tip 5 may be replaced with another input pen module provided with a different input tip. When the holder 4 is formed of a flexible synthetic resin and the back end part of the holder 4 is formed in a diameter greater than the inside diameter of the slide cam 9, the holder 4 does not fall through the bore of the slide cam 9 and the input pen module can be replaced with another one.

Since the input tip 5 can be removed from the holder 4, the input tip 5 can be very easily replaced with a new one when the input tip 5 is abraded excessively regardless of the hardness of the tip.

The input tip 5 may be attached to the holder 4 and the holder 4 may be connected to the slide cam 9 by a screw mechanism or by staking instead of by press fitting.

The component modules of the multifunctional input pen may be operated to project their tips from the barrel by any suitable, known operating method, for example a method of pushing a projection on the side of the pen in axial direction, instead of the rotating method that rotates the back barrel relative to the front barrel; that is, the component modules of the multifunctional input pen may be operated by any operating method and the component modules may be operated by any projecting and retracting mechanism.

Although the invention has been described in its preferred embodiments with a certain degree of particularity, obviously many changes and variations may be made therein. It is therefore to be understood that the present invention may be practiced otherwise than as specifically described herein without departing from the scope and spirit thereof.

What is claimed is:

1. An input pen comprising: a barrel; a tip holder held in the barrel; and a soft input tip having a low hardness or a hard input tip having a high hardness detachably attached to the holder.

2. The input pen according to claim 1, wherein the holder is a flexible, hollow pipe, and an inside diameter of a front end part of the holder is slightly smaller than an outside diameter of the input tip.

3. An input pen comprising: a barrel, an input pen module having a holder and a soft or hard input tip fitted in a front end part of the holder, and a holding member disposed in the barrel and detachably connected to the holder.

4. The input pen according to claim 3, wherein the holder is a flexible pipe, and an outside diameter of a back end part of the holder is slightly greater than an inside diameter of a holding hole of the holding member.

5. An input pen comprising: a barrel; a soft input pen module including a holder and a soft input tip having a low hardness and connected to a front end part of the holder; and a hard input pen module including a holder and a hard input tip having a high hardness and connected to a front end part of the holder; wherein the soft and the hard input pen module are axially movable in the barrel, and are moved selectively to project the soft input tip or the hard input tip from the barrel.

6. The input pen according to any one of claims 1 to 5, wherein the soft input tip has a durometer hardness in the range of 55° to 69° and the hard input tip has a durometer hardness in the range of 70° to 85°.

7. The input pen according to any one of claims 1 to 5, wherein the soft input tip is formed of a semirigid polyethylene resin and the hard input tip is formed of a POM resin.

8. The input pen according to any one of claims 1, 3 and 5 further comprising at least one of bar-shaped modules including a mechanical pencil module, a ballpoint pen module, color pencils, an eraser and chalks, and the input pen module and the bar-shaped modules are used selectively.
